(19) United States
(12) Patent Application Publication
(10) Pub. No.: US 2014/0079477 A1
(43) Pub. Date: Mar. 20, 2014

(54) Adjustable Length Titanium Vaporizing Instrument

(71) Applicants: Larry Duarte, Centennial, CO (US); Chris Keller, Centennial, CO (US); Nicki Abrahamson, Centennial, CO (US)

(72) Inventors: Larry Duarte, Centennial, CO (US); Chris Keller, Centennial, CO (US); Nicki Abrahamson, Centennial, CO (US)

(21) Appl. No.: 13/621,304

(22) Filed: Sep. 17, 2012

(51) Int. Cl. F16B 7/18

(52) U.S. Cl. 403/343

(57) ABSTRACT

A vaporizing instrument used for smoking and consisting of two parts, the upper adjustable head and the fixed lower body. The instrument is used to vaporize herbal medicines or any other fluid capable of being vaporized. The lower body is fixed in length and has threaded hole for upper head, lower body may also have fins and counterweight. The upper head consist of cup to hold vaporizing fluid and is attached to threaded column which is inserted into the lower body. The threads allow the user to adjust length of upper head to desired height. Entire instrument is made of commercially pure titanium.

### CROSS-REFERENCE TO RELATED APPLICATIONS

This application claims the benefit of provisional patent application Ser. No. 61/626,114, filed Sep. 21, 2011 by the present inventors.

### BACKGROUND

### Prior Art

The following is a tabulation of some prior art that presently appears relevant:

### NONPATENT LITERATURE DOCUMENTS

http://heat-that-ti.com/power-tower/, “POWER TOWER” (December 2010)
http://www.glassdistrict.com/forums/f63/kabley-v4-ti-nails-4996/, “Kabley V4 Ti-Nails” (March 2010)
http://www.icmag.com/ic/showthread.php?s=8959a2e55a73277898eea1300bb4c227&t=221727, “First Fully Adjustable Titanium Nail” (September 2011)

Consumers have a need and desire to inhale the vapor of various combustible materials such as medicines, oils, and tobacco. A heated surface is needed to heat the desired material to vaporizing temperature and produce vapor.

Originally simple surfaces such as knife blades or stakes were heated with lighter or torch and material applied which created vapor that was then inhaled, either directly or through cooling apparatus such as a water pipe.

The obvious disadvantage was the difficulty of working with the vaporizing instrument and redirecting the vapor to a cooling apparatus. The not so obvious problem was the harmful fumes emitted by various metal alloys. Reputable manufactures of these instruments adopted the standard of using commercial grade 2 titanium which does not emit fumes when heated to proper temperatures. The overall shape of the vaporizing instrument was changed to resemble a ‘nail’ which could easily fit within the joint of a typical water pipe allowing for easy cooling of the emitted vapor. From this the colloquial name ‘Ti-Nail’ was born.

Prior to September 2011 all versions of the vaporizing instrument were static in length. Examples of this type are Ti Power Einstein (2010), Kabley V4 Ti-Nails (2010), and Highly Educated V1 & V2 (2010). The disadvantage to this design is the fixed length. To trap the vapor a glass dome is placed over the vaporizing instrument which sits in the joint of the cooling apparatus, typically a water pipe. The fixed length does not work well with the hundreds of different size joint/glass dome combinations used by the consumer.

The solution is to be able to change the height of the head of the vaporizing instrument in relationship to where it sits in the joint of the cooling apparatus. One effort to address this is Highly Educated V3 (September 2011). The V3 consists of four parts: the head (which gets heated and vaporizes material), the bottom counterweight, the center fin rest (which suspends the vaporizing instrument in the joint), and the threaded rod that the other pieces screw onto. This solution did not change the actual length of the instrument, but by moving the center fin rest up or down, the head moved up or down in relationship to the joint and within the glass dome. This design has numerous problems the most severe being the instability of the instrument when the center fin rest is screw all the way down to elevate the head. In this position the instrument will easily fall out of the joint.

All vaporizing instruments heretofore known suffer from a number of disadvantages:

(a) Static length which hinders proper use of that instrument when used in different model cooling apparatuses. In some cases the instrument will be totally unusable.

(b) Adjustable versions of the vaporizing instrument do not change the top to bottom length but only the position of the center fin rest.

(c) Adjustable versions of the vaporizing instrument can become unstable and fall out of cooling device during use.

(d) Adjustable versions have excessive number of pieces which can come undone during use.

### SUMMARY

In accordance with one embodiment a vaporizing instrument that consist of two parts and allows the total length of said instrument to change.

### ADVANTAGES

Accordingly several advantages of one or more aspects are as follows: Overall length of instrument is adjustable, does not lose stability as length is adjusted, rugged two piece design, optional top head sizes for same bottom piece.

### DRAWINGS

### Figures

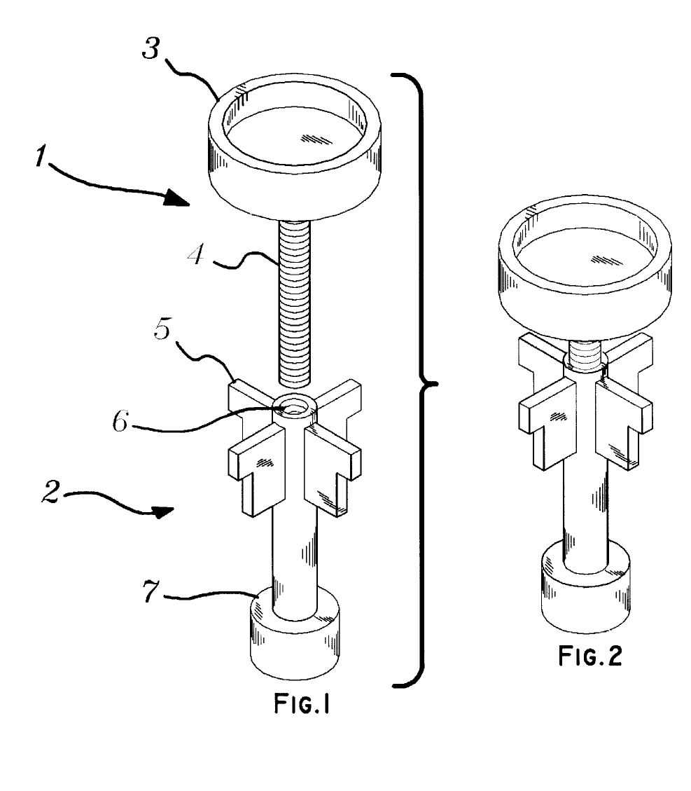

FIG. 1 shows the two independent parts of the embodiment, the top and bottom parts.

FIG. 2 shows the parts together and in operational state.

### REFERENCE NUMERALS

| | |
|---|---|
| 1 | top |
| 2 | bottom |
| 3 | head |
| 4 | threaded rod |
| 5 | fins |
| 6 | threaded hole |
| 7 | counterweight |

### DETAILED DESCRIPTION

### FIGS. 1 and 2

One embodiment of the vaporizing instrument is illustrated in FIG. 1 (exploded view) and FIG. 2 (assembled view). The top 1 comprises of a head 3 which is cup shaped and permanently attached to threaded rod 4. The threaded rod 4 is the same size, pitch, and length as the threaded hole 6 in bottom 2. The bottom 2 is a single piece of metal which has fins 5 for a center rest, bottom counterweight 7, and vertical threaded hole 6 which is the same size, pitch, and length as the threaded rod 4. All parts shown in FIG. 1 and FIG. 2 are made from grade 2 titanium.

### Operation

### FIG. 2

Length of vaporizing instrument is adjusted by turning the top 1 while holding the bottom 2 stationary. When proper head 3 height is reached for the cooling apparatus, place vaporizing instrument into joint of cooling apparatus. Heat head 3 with lighter or torch until proper temperature is reached. Cover vaporizing instrument with glass dome and drop material onto head 3.

### Advantages

From the description above, a number of advantages of our vaporizing instrument become evident:

(a) Ability to change length of instrument to match any model cooling apparatus.

(b) Stability does not change as length changes.

(c) Inability to tip over.

(d) Rugged two piece design.

(e) Optional top sizes for same bottom piece.

(f) Made from commercially pure grade 2 titanium.

### Conclusion, Ramifications, and Scope

Accordingly, the reader will see the greatly enhanced usability of the vaporizing instrument. All known cooling apparatuses can use this vaporizing instrument. This is accomplished without sacrificing stability or reliability. Furthermore, the vaporizing instrument has the additional advantages in that:

it permits production of optional size heads for same bottom part;

simplicity over other adjustable designs; and

true length adjustment over other adjustable designs.

Although the description above contains many specificities, these should not be construed as limiting the scope of the embodiment but as merely providing illustrations of one possible embodiment. For example, the vaporizing instrument can have other shapes for the center fins, such as triangular, or the head oval, square, etc; the counterweight can be larger or reduced in size, or different in shape, etc.

Thus the scope of the embodiment should be determined by the appended claims and their legal equivalents, rather than by the examples given.

I claim:

1. A device for vaporizing combustible materials, consisting of:
a. a top constructed entirely from commercially pure grade 2 titanium, comprising of cup shaped head and a threaded rod;
b. a bottom constructed entirely from commercially pure grade 2 titanium, comprising of threaded hole, fins, and counterweight.

2. A device according to claim 1 wherein the said top comprising a cup head attached to threaded rod.

3. A device according to claim 2 and further comprising said threaded rod to said cup head in one integrated piece.

4. A device according to claim 1 wherein the said bottom comprises threaded hole, fins, and counterweight.

5. A device according to claim 4 and further comprising said threaded hole along vertical axis.

6. A device according to claim 4 and further comprising of said counterweight on opposite side of said threaded hole.

7. A device according to claim 4 and further comprising of said fins at top of said bottom.

8. A device according to claim 1 wherein the said top screws into the said bottom, whereby permits adjusting length of said device.
